(19) United States
(12) Patent Application Publication
(10) Pub. No.: US 2010/0190429 A1
(43) Pub. Date: Jul. 29, 2010

(54) VARIABLE HVAC AIRFLOW CONTROL

(75) Inventor: Gerhard A. Dage, Franklin, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/359,603

(22) Filed: Jan. 26, 2009

(51) Int. Cl. B60H 1/00; G05D 7/00

(52) U.S. Cl. 454/75; 454/140; 700/282

(57) ABSTRACT

A method and apparatus for controlling the air flow entering a passenger compartment of an automotive vehicle. The position of a valve or door in the vehicle air duct system is varied between a full-fresh air position and a full-recirculated air position to produce a controlled relationship between a fan speed selected by a vehicle occupant and a desired air flow rate into the passenger compartment over a wide range of vehicle speeds.

### BACKGROUND

1. Technical Field

The invention relates to climate control systems for automotive vehicles, otherwise known as heating, ventilating, and air-conditioning (HVAC) systems. More specifically, the invention relates to a system for controlling the ambient air/recirculated air supplied to the passenger compartment of an automotive vehicle.

2. Background Art

Automotive vehicle climate control systems commonly include a blower or ventilation fan (typically powered by an electric motor) operative to force air through ducting into the vehicle passenger compartment, also known as the cabin. The air supplied to the passenger compartment may be either ambient air from outside the vehicle (fresh air) or air that is recirculated from inside the passenger compartment (recirc air).

Typically, vehicle occupants may select between fresh air and recirc air using a manual, two-position switch. Some climate control systems also include one or more modes where the selection between fresh and recirc air is made automatically, without the occupant actuating a switch. A known example of such an automatic setting is when the HIGH or MAX setting of air conditioning is selected the system may switch from fresh air to recirc air in order to speed cooling of the passenger compartment.

Control over the speed of the fan and consequently the rate (which may be expressed in either velocity or volume rate) of the air entering the passenger compartment via the ducting may also be manual or automatic. In a manual mode, a vehicle occupant actuates a switch to select between several (commonly from 3 to 5) discrete fan speeds. If the vehicle occupant selects the automatic mode, a controller unit applies programmed logic and memory to vary the fan speed based on factors such a desired temperature, actual temperature, ambient light, etc., with the objective of providing maximum passenger comfort.

A problem previously not solved by climate control systems is to provide a consistent relationship between a specific selected fan speed (whether that speed is selected manually or automatically) and the actual flow rate of air issuing from the vents and entering the passenger compartment. A ram-air effect through the vehicle ventilation system may result in a higher air flow rate into the passenger compartment than selected when the vehicle is traveling at a relatively high speed and fresh air (as opposed to recirc) is selected. It is known to use a “ram air compensation” technique which calls for a reduction in the fan speed when the vehicle is traveling at high speed. However, this technique does not resolve th problem when a low fan speed is selected and the ram air effect causes a greater then desired air flow rate into the passenger compartment.

### SUMMARY

In a first disclosed embodiment, an apparatus for controlling environmental conditions within a passenger compartment of an automotive vehicle comprises a valve controlling an amount of fresh air admitted to the passenger compartment and an amount of recirculated air admitted to the passenger compartment. The valve is variable between a minimum recirc position wherein the amount of recirculated air is relatively low compared to the amount of fresh air and a maximum recirc position wherein the amount of recirc air is relatively high compared to the amount of fresh air. A variable speed ventilation fan controls the supply of air to the passenger compartment. A control module is operative to control movement of the valve between the minimum recirc position and the maximum recirc position based at least in part upon a vehicle speed input and a ventilation fan speed input. This embodiment of the invention contributes to passenger comfort by eliminating or minimizing a higher-than-desired air flow rate into the passenger compartment at relatively high vehicle speeds and relatively low fan speeds.

In a method according to an embodiment of the disclosure, air flow entering a passenger compartment of an automotive vehicle is controlled by varying the position of a fresh/recirc valve. The method comprises the steps of selecting a fan speed corresponding to a desired air flow rate into the passenger compartment, determining that at an actual vehicle speed and with the fresh/recirc valve in a minimum recirc position an expected air flow rate into the passenger compartment is greater than the desired air flow rate, and positioning the fresh/recirc valve at an intermediate position between the minimum and maximum recirc positions to achieve an actual air flow rate lower than the expected air flow rate.

### BRIEF DESCRIPTION OF THE DRAWINGS

FIG. 1 is a schematic depiction of an automotive vehicle climate control system;

FIG. 2 is a block diagram showing in schematic form the components of the climate control system of FIG. 1;

FIG. 3 is a look-up table of for use in the disclosed embodiment;

FIG. 4 is a table showing the relationship between fan speed settings and air flow rate for a single vehicle speed; and

FIG. 5 is a graph of the data of FIG. 4.

### DETAILED DESCRIPTION

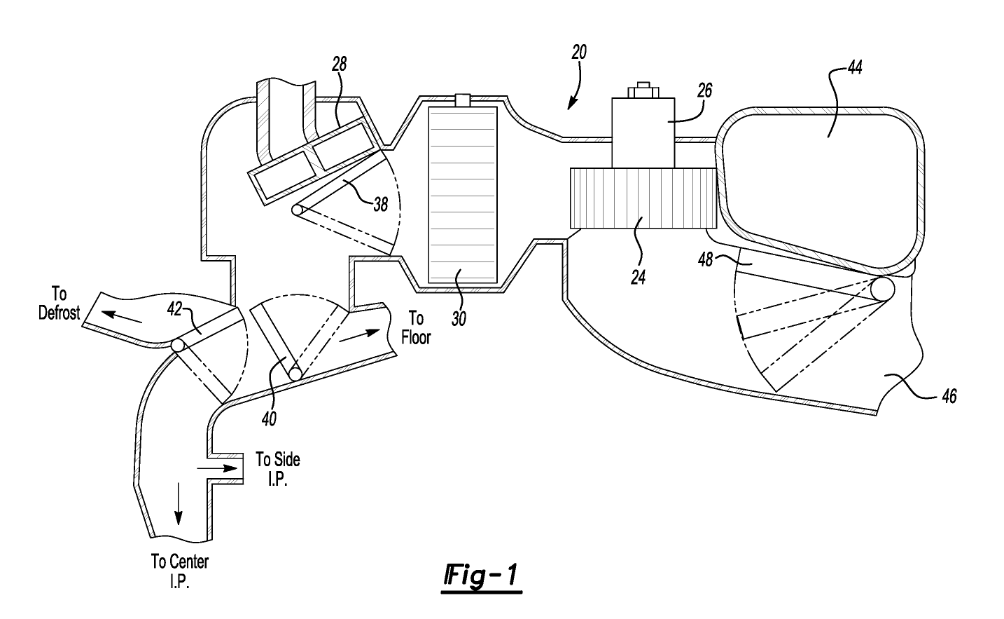

FIG. 1 shows in schematic form the general configuration of an automotive vehicle climate control system. The system includes a system of ducting, generally indicated at 20, for carrying air to outlets or vents in various parts of the vehicle passenger compartment. A fan or blower 24 is positioned in within the ducting and is powered by a variable-speed electric motor 26. Heating and cooling elements such as a heater core 28 and an air conditioner (AC) evaporator core 30 are disposed downstream from fan 24 and may be activated to heat and/or cool/dehumidify the air supplied to the passenger compartment as desired. A temperature blend door 38 is movable to obtain a desired mixture of heated and cooled/dehumidified air.

Airflow through particular ducts leading to different parts of the passenger compartment is regulated by one or more movable air distribution doors 40, 42 located within the ducting. For example, panel/defrost door 42 is movable to apportion airflow between center and/or side instrument panel vents (not shown) and front/side window defrost vents (not shown), while panel/floor door 40 is movable to apportion airflow between the instrument panel vents and a floor vent (not shown). Doors 38, 40, and 42 are preferably powered by electric motors (not shown) but may be actuated by any appropriate motive means, such as a vacuum system.

A fresh air duct 44 leads to fan 24 from outside the passenger compartment, and recirc air duct 46 leads to fan 24 from collector vents (not shown) located inside the passenger compartment. A Fresh/Recirculate (F/R) door 48 is movable to control the amount or proportion of fresh air from the outside of the vehicle and recirculated air from the inside of the cabin. F/R door 48 is shown in solid lines in a maximum recirc position wherein substantially all of the airflow supplied to the cabin is recirculated from inside the cabin and fresh air duct 44 is substantially completely blocked. This maximum recirc position preferably supplies close to 100% recirc air, and will be referred to herein as such, but it should be understood that some amount of fresh air may be supplied.

The lowermost position of F/R door 48 shown in broken lines represents the minimum recirc position, also referred to as a “fresh” position, wherein substantially all of the airflow supplied to the cabin is fresh air, recirc air being completely or nearly completely blocked. This minimum recirc position preferably supplies close to 0% recirc air. However, the fresh or 0% recirc position does not exclude the case where some minimum amount of recirc air is supplied.

The center position of F/R door 48 shown in broken lines represents an intermediate position between the maximum and minimum recirc positions. In an intermediate F/R door 48 position some desired mixture of fresh and recirc air is admitted to the cabin. Preferably, F/R door 48 may be placed in any of a range of intermediate positions between the min and max recirc positions.

Accordingly, F/R door 48 functions as a valve that controls the amount of fresh air versus the amount of recirc air admitted to the passenger compartment through the ducting system 20.

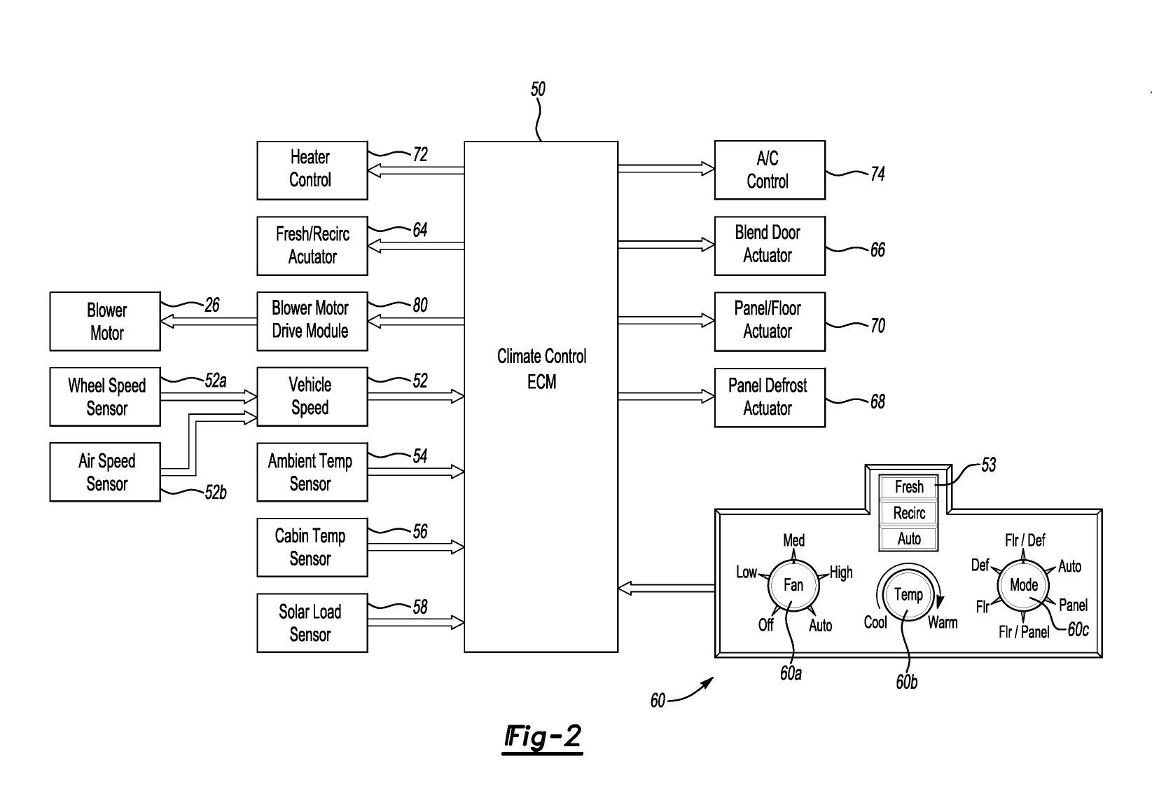

Referring now to FIG. 2, the climate control system further includes a programmable electronic control module (ECM) generally designated 50. ECM 50 receives inputs from one or more sensors including (but not limited to) a vehicle speed sensor 52, an ambient (external to the vehicle) temperature sensor 54, a passenger compartment temperature sensor 56, and a solar load sensor 58. A control assembly 60 include knobs or selectors such as fan control 60a (labeled FAN), temperature control 60b (TEMP), and mode control 60c (MODE). Control assembly 60 also provides an input to ECM 50.

Control selectors 60a-c, 62 are used by the vehicle operator to select desired climate/comfort setting and provide input commands to the ECM 50. While control assembly 60 is depicted in FIG. 2 as comprising mechanical, rotatable knobs, it may also comprise any combination of push-buttons, touch-screen controls, a voice-actuated control system, or any appropriate means to allow operator selection of the various control settings.

Control assembly 60 may also include, as is well known in the art, a Fresh/Recirc select switch 53 that allows an occupant to manually select between 100% fresh air (minimum recirc), 100% recirc air (maximum recirc), and an AUTO setting.

Fan control 60a allows a vehicle occupant to select or command a desired air flow rate by setting a fan speed to, for example, OFF, LOW, MED, HIGH, or AUTO.

Mode selector 60c allows a vehicle occupant to select the location of the vents to which air supplied by fan 24 is directed. PANEL, FLOOR, FLR/PANEL, DEF, FLR/DEF, and AUTO settings are examples of mode settings commonly used in the automotive industry, and other possibilities and combinations exist.

AS is well known in the art, ECM 50 is preferably a microprocessor-based unit that controls the various motors and actuators of the climate control system based upon the various sensor and control inputs and in accordance with programmed logic and memory.

ECM 50 controls a fresh/recirc actuator 64, a blend door actuator 66, a panel/defrost actuator 68, and a panel/floor actuator 70, these actuators respectively moving recirc door 48, temperature blend door 38, panel/defrost door 42, and panel/floor door 40. Actuators 64, 66, 68, and 70 are preferably electric motors, but may alternatively be any appropriate motive means, such as a vacuum system.

ECM 50 also provides control signals to a heater controller 72 and an air conditioner controller 74 which control the amount of heating and cooling delivered by heater core 28 and AC core 30 respectively.

The ECM 50 controls fan motor 26 through a fan motor drive module 80 in response to fan settings of OFF, LOW, MED, HIGH, and AUTO as made by the operator using fan control 60a. In the OFF mode the ECM 50 may command fresh/recirc actuator 62 to move F/R door 48 to the 100% recirc position to minimize the entry of undesirable odors into the vehicle and completely turns off all climate control components. When an air flow rate (fan speed) is selected by an occupant using fan control 60a, the ECM 50 sends a signal to the module 80 to control the speed of the fan motor 26. The set or range of fan speeds to be used may depend on the operating mode selected and may be contained in look-up tables in the memory of ECM 50.

When fan selector 60a is set to the AUTO setting, ECM 50 applies preprogrammed logic and memory to determine and direct, based upon sensor and operator control inputs, the correct temperature, mode, and fan speed required to achieve maximum comfort in the cabin. During automatic control, fan motor drive module 80 may continuously vary the fan speed by adjusting the voltage powering fan motor 26 anywhere between zero volts (fan off) and the maximum system voltage (fan full speed). Typical passenger vehicles, at the time of this writing, utilize a 14 volt (14V) electrical system, so 14V shall be considered to equate to fan full speed for the purposes of this disclosure.

When F/R door 48 is in the fresh position, the air flow rate (which may be measured and expressed as velocity and/or volume rate) of air entering and passing through ducting system 20 is at least partially dependent upon the speed of the vehicle through the air mass outside the vehicle. It may be assumed that the vehicle airspeed is equal to the vehicle's ground speed as detected by wheel speed sensors 28a used by the vehicle speedometer. However, a more accurate airspeed could be measured if the vehicle is equipped with an appropriate airspeed sensor 60b. An airspeed sensor 52b could also be located within the climate control system ducting at a point where it would give an accurate indication of the velocity of the air entering or about to enter the cabin.

At relatively low fan speed settings the ram air effect of outside air entering through fresh air duct 44 may result in the air flow into the cabin being greater than that called for by ECM 50. For a particular vehicle climate control system there is a lower vehicle speed boundary below which the ram air effect does not significantly affect the cabin air flow but above which the delivered air flow rate will be greater than desired. The lower vehicle speed boundary depends primarily on the internal configuration of the ducting and the amount of resistance to air flow provided by that configuration. Among the determining factors may be the bends and/or constrictions in the ducting and the size, type, and configuration of AC evaporator core 2. The critical speed for a particular model of vehicle is most accurately determined by road and/or wind tunnel testing.

ECM 50 executes a program that directs F/R door 48 to move away from the full fresh (minimum recirc) position and towards the full (or maximum) recirc position so as to reduce or eliminate the undesirable ram air effect. Preferably, ECM 50 may direct F/R door 48 to a range of intermediate positions between fresh and recirc.

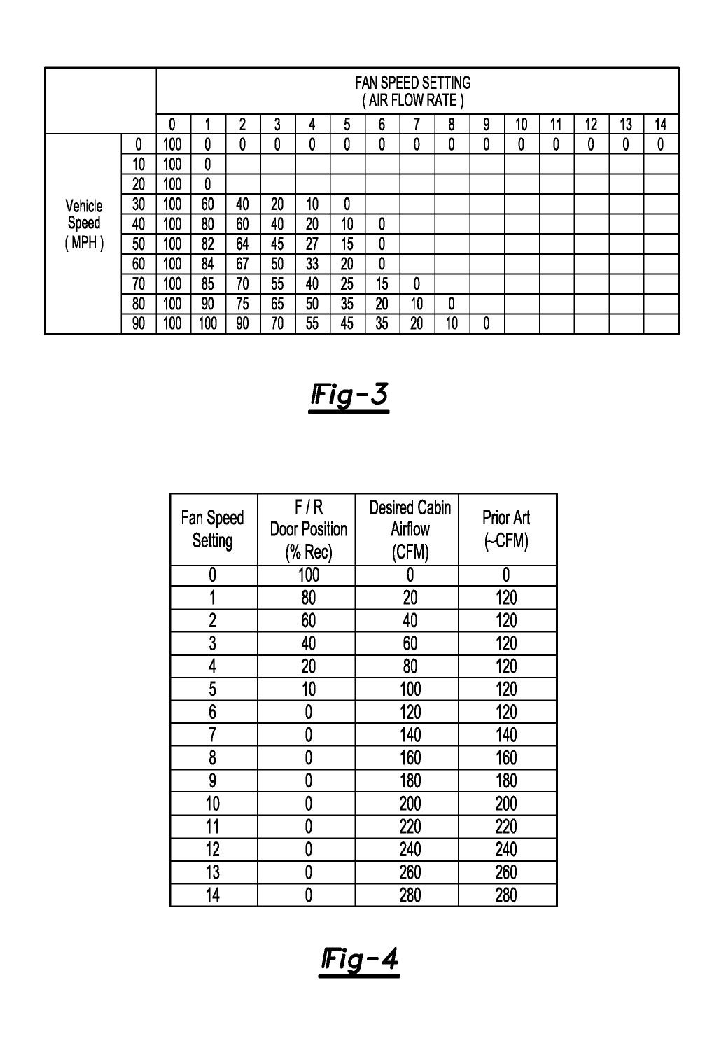

FIG. 3 is a look-up table as may be used by ECM 50, in the practice of one embodiment of the invention, to schedule the position of F/R door 48. In FIG. 3, the vertical axis is vehicle speed (or airspeed) in miles per hour (MPH), and covers a normal operating range of from 0 MPH to 90 MPH. The horizontal axis is the selected ventilation fan speed and shows the range of possible fan speed settings as expressed in volts supplied to the fan motor, ranging from 0V (fan off) to 14V (fan full), as may be directed by ECM 50 when in AUTO mode. The fan speed range may also be expressed as a desired air flow rate.

The values populating the cells of the FIG. 3 table are the F/R door 48 position commanded by ECM 50 in order to achieve the desired air flow rate at each given speed point or range. The F/R door positions are expressed in % (per cent) recirculated air, with 0% corresponding to the door positioned to admit full or maximum fresh air (F/R door 48 shown in dashed lines in FIG. 1) and 100% corresponding to the door positioned to admit full or maximum recirc air (F/R door 48 shown in solid lines in FIG. 1). Empty cells in the FIG. 3 table are 0% recirc.

For example, at a speed of 70 MPH and with the fan speed set at 2V, ECM 50 commands F/R door 48 to an intermediate position corresponding to 70% recirc air. At the 70% recirc position, F/R door 48 blocks a substantial amount of the fresh air that would be entering the passenger compartment through fresh air duct 44 if the F/R door 48 were at 0% recirc. Accordingly, the 70% recirc setting reduces the ram air effect caused by the vehicle travelling at 70 MPH so that the desired air flow rate is achieved.

If the fan speed setting is increased to 6V, indicating a greater desired air flow rate into the passenger compartment, ECM 50 commands F/R door 48 to an intermediate position corresponding to 15% recirc air, thereby increasing the amount of fresh air admitted and so increasing the air flow rate into the cabin.

AS may be seen from FIG. 3, at speeds below a lower speed boundary of 30 MPH it is not necessary to position F/R door 48 at a position other than 0% recirc (full fresh) regardless of fan speed setting, because the ram air effect is not significant below that speed. At the other end of the speed range, there may be an upper speed boundary at which F/R door 48 is commanded to 100% recirc position at all fan speed settings. This upper speed boundary is not reflected in FIG. 3.

FIG. 4 is a table showing the relationship between fan speed settings and air flow rate for a vehicle speed of 40 MPH. The leftmost column shows possible fan speed settings as expressed in volts supplied to the fan motor. The next column (second from the left) shows the corresponding position of F/R door 48 that will be commanded for each fan speed setting, expressed in % recirc air. The next column (third from the left) of FIG. 4 shows the resulting/desired airflow output for each fan speed setting, expressed in cubic feet per minute (CFM). As seen in the table, the F/R door 48 position is scheduled to achieve a smoothly increasing, preferably substantially linear, relationship between commanded fan speed and airflow output. The term “substantially linear” is to be interpreted as allowing a deviation from a mathematically linear relationship of up to 20%.

The rightmost column of FIG. 4 shows, for comparison, an example of the air flow that may be expected from a climate control according to the prior art in which the F/R door 48 is maintained in the maximum fresh (0% recirc) position at all fan speed settings. The ram air effect of the vehicle traveling at over 40 mph causes the airflow to be higher than desired at all fan speed settings up to 6V. Above that fan speed setting, the ram air effect becomes negligible.

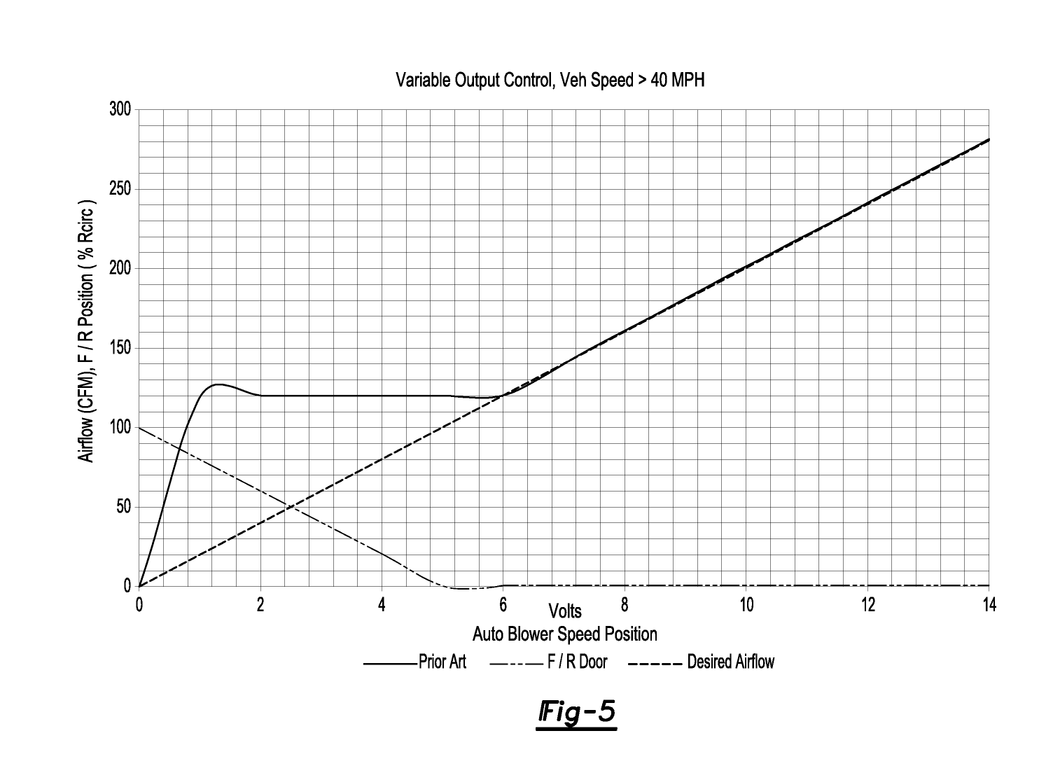

FIG. 5 shows the relationships of FIG. 4 in graphical form. The curve in the broken/hidden line depicts the scheduling of F/R door 48 position (in % recirc indicated on the vertical axis) from FIG. 4 versus fan speed (in Volts, indicated on the horizontal axis. When the fan is off, no airflow desired, the F/R door 48 completely closes off the flow of fresh air and so is at the 100% recirc position. As the fan speed is increased, commanding an increase in the desired airflow, F/R door 48 moves gradually towards decreased recirc (increased fresh). The dashed line shows the cabin air flow that results from this scheduling of F/R door position, and clearly illustrates the desired linear fan speed/airflow rate curve.

The curve in the solid line of FIG. 5 shows the airflow produced by the prior art (the rightmost column of FIG. 4). The highly non-linear nature of the relationship at low fan speeds is apparent.

As previously stated, FIGS. 4 and 5 relate to an embodiment of the invention where the vehicle speed is 40 mph and the climate control mode is in AUTO so that fan speed is continuously varied. The invention, however, can be practiced with any selected vehicle speed and/or with the climate control in a mode where the vehicle occupant selects a fan speed manually.

For example, if the manual fan speed control has three setting (LO, MED, HIGH) the present invention as applied to this system may require that the F/R door 48 position schedule be other than 0% recirc only at the LO setting. Similarly, if more than three manual fan speed settings are available for selection by a vehicle occupant, the F/R door 48 position may be in the max recirc or the intermediate position at two or more of the lower fan speeds.

The embodiment of the invention described herein uses an F/R door 48. The scope of the invention, however, includes other types of mechanisms and ducting that may serve as a valve that controls or selects the amount or proportion of fresh and/or recirc air admitted to the cabin.

While the best mode for carrying out the invention has been described in detail, those familiar with the art to which this invention relates will recognize various alternative designs and embodiments for practicing the invention as defined by the following claims.

What is claimed:

1. An apparatus for controlling air flow into a passenger compartment of a vehicle, comprising:
a valve controlling an amount of fresh air and an amount of recirculated air admitted to the passenger compartment, the valve movable between a minimum recirc position and a maximum recirc position;
a variable speed ventilation fan; and
a control module controlling movement of the valve between the minimum recirc position and the maximum recirc position based at least in part upon a vehicle speed input and a ventilation fan speed input.

2. The apparatus of claim 1 wherein the valve comprises a fresh/recirc door operable to substantially block a recirc air duct when in the minimum recirc position and to substantially block a fresh air duct when in the maximum recirc position, the fresh/recirc door being movable to at least one intermediate position between the minimum and maximum recirc positions.

3. The apparatus of claim 1 wherein the control module receives the vehicle speed input from at least one wheel speed sensor.

4. The apparatus of claim 1 wherein the control module receives the vehicle speed input from at least one air speed sensor.

5. The apparatus of claim 1 wherein the ventilation fan has at least one automatic speed control setting.

6. The apparatus of claim 1 wherein the ventilation fan has at least one manual speed control setting.

7. The apparatus of claim 1 wherein the control module directs the valve to the minimum recirc position when the vehicle speed input indicates an actual vehicle speed below a lower vehicle speed boundary.

8. The apparatus of claim 1 wherein the control module is an electronic control module in overall control of a climate control system for the passenger compartment.

9. The apparatus of claim 1 wherein the control module uses at least one look-up table to determine the fresh/recirc valve position.

10. The apparatus of claim 1 wherein the control module positions the valve to achieve a substantially linear relationship between the fan speed input and an actual air flow rate entering the passenger compartment.

11. A method of controlling air flow entering a passenger compartment of an automotive vehicle having a climate control system comprising a fresh/recirc valve movable between a minimum recirc position and a maximum recirc position, the method comprising:
selecting a fan speed corresponding to a desired air flow rate into the passenger compartment;
determining that at an actual vehicle speed an expected air flow rate into the passenger compartment is greater than the desired air flow rate; and
positioning the fresh/recirc valve between the minimum and maximum recirc positions to achieve an actual air flow rate lower than the expected air flow rate.

12. The method of claim 11 wherein the fresh/recirc valve is positioned to achieve a substantially linear relationship between fan speed and actual air flow rate at the actual vehicle speed.

13. The method of claim 11 wherein the step of selecting the fan speed is accomplished by a manual speed control.

14. The method of claim 11 wherein the step of selecting the fan speed is accomplished by an automatic speed control.

15. The method of claim 11 wherein if the actual vehicle speed is below a lower vehicle speed boundary the fresh/recirc valve remains is the minimum recirc position.

16. The method of claim 11 wherein the positioning step comprises using at least one look-up table stored in a control module.

17. A climate control system for a passenger compartment of an automotive vehicle, the system comprising:
a fresh air duct carrying fresh air from outside the passenger compartment;
recirc air duct carrying recirculated air from inside the passenger compartment;
a fresh/recirc door having a fresh position wherein the recirc air duct is substantially blocked, a recirc position wherein the fresh air duct is substantially blocked, and at least one intermediate position between the fresh position and the recirc position;
a fan speed controller operable by a vehicle occupant to set a desired air flow rate; and
a control module controlling movement of the fresh/recirc door based at least in part upon receiving a desired air flow rate input and a vehicle speed input.

18. The climate control system according to claim 17 wherein the control module instructs the fresh/recirc door to the fresh position when the vehicle speed input indicates an actual vehicle speed lower than a lower vehicle speed boundary.

19. The climate control system according to claim 17 wherein the control module uses a look-up table to control movement of the fresh/recirc door.
